(19) United States
(12) Patent Application Publication
(10) Pub. No.: US 2005/0088570 A1
(43) Pub. Date: Apr. 28, 2005

(54) Lighting device for photographing apparatus and photographing apparatus

(75) Inventor: Shuzo Seo, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/968,955

(22) Filed: Oct. 21, 2004

(30) Foreign Application Priority Data
Oct. 22, 2003 (JP) P2003 - 361848

(51) Int. Cl. H04N 5/222

(52) U.S. Cl. 348/371

(57) ABSTRACT

A photographing apparatus for photographing an object comprises a lighting device. The light device has a light source and a light-control apparatus. The light source radiates pre-imaging light before the object is photographed, and radiates imaging light when the object is photographed. The light-control apparatus controls the light source so that the quantity of the pre-imaging light is smaller than that of the imaging light.

### BACKGROUND OF THE INVENTION

1. Field of the Invention

The present invention relates to a lighting device for photographing apparatus, in particular a portable apparatus having photographing device for example a digital camera, a portable telephone, and so on.

2. Description of the Related Art

Conventionally, it is suggested that besides xenon lamps, semiconductor lighting devices, for example a white LED (light emitting diode), can be used as lighting devices for a photographing apparatus. While semiconductor lighting devices have the advantage of higher luminous efficiency, the quantity of light they produce is small.

A lighting device for photographing, having a white LED as the light source, is disclosed by Japanese Unexamined Patent Publication (KOKAI) NO.2003-101836 for example. In this reference, the photographing apparatus can photograph a moving image by forming many object image frames intermittently. And the lighting device radiates a strobe light intermittently only during the period each frame is being formed.

However, it is difficult to confirm the composition of the image before photographing the object when the object is in the dark, for example at night. On the other hand, even if the lighting device intermittently radiates strobe light while forming a moving image, excess electricity is consumed and the electric charge in a battery runs down almost immediately.

### SUMMARY OF THE INVENTION

Therefore, an object of the present invention is to provide a lighting device, which can make it easy to confirm the composition of an image of an object before photographing when the object is in the dark, while the amount of electricity consumed is restrained.

According to the present invention, there is provided a lighting device for a photographing apparatus. The lighting device comprises a light source and a light control apparatus. The light source radiates illumination light to an object, and the illumination light is either a pre-imaging light or an imaging light. The light-control apparatus controls the light source in such a manner that the pre-imaging light is radiated before the object is photographed, and the imaging light is radiated when the object is photographed. The light-control apparatus further controls the quantity of the pre-imaging light to be smaller than the quantity of the imaging light.

Preferably, the light-control apparatus controls the timing when the illumination light is radiated and the quantity of the illumination light, and further changes at least one of the radiation period and the intensity of the illumination light in order to control the brightness of the pre-imaging light and the imaging light.

When the pre-imaging light comprises a light-pulse series which has a predetermined radiation cycle and which repeats a radiation period and a stop radiation period, the light-control apparatus changes at least one of the intensity of the light pulse and the radiation period.

If the lighting device further comprises a detection apparatus that detects the luminance of the object, the light-control apparatus controls the light source in such a manner that the pre-imaging light is radiated when the luminance is less than a predetermined luminance. In this case, the quantity of the pre-imaging light is preferably determined based on the luminance.

Preferably, the lighting device further comprises a switching apparatus for switching between a light mode and a luminance depend mode. The light-control apparatus controls the light source in such a manner that the pre-imaging light is radiated not based on the luminance when the light mode is selected, but is radiated based on the luminance when the luminance depend mode is selected.

Preferably, the light source includes a semiconductor lighting device radiating white light.

The light-control apparatus can comprise a detection apparatus, a pulse generation circuit, and a smoothing circuit. The detection apparatus detects a luminance of the object. The pulse generation circuit generates a drive pulse signal. The drive pulse signal has ON-period time and OFF-period time per unit time. The ON-period time and the OFF-period time are controlled based on the luminance. The smoothing circuit smoothes the drive pulse signal so as to generate a smoothed drive signal. The smoothed drive signal is input to the light source so that the light source radiates the illumination light based on the luminance.

According to the present invention, there is provided a photographing apparatus. The photographing apparatus comprises a light source, a light-control apparatus, an image device, and an indicating device. The light source radiates illumination light to an object. The illumination light comprises pre-imaging light and imaging light. The light-control apparatus controls the light source in such a manner that the pre-imaging light radiates before the object is photographed, and the imaging light radiates when the object is photographed. The quantity of the pre-imaging light is smaller than the quantity of the imaging light. The image device forms an object image from the object. The indicating device displays the object image.

Preferably the pre-imaging light is radiated to the object in order to observe the object image on the indicating device.

If the photographing apparatus further comprises an operation device, preferably the pre-imaging light is radiated when the operation device is operated for displaying the object image, and the imaging light is radiated when the operation device is operated for photographing the object.

If the image device is repeatedly exposed when the operation device is operated for displaying the object image, the pre-image light is radiated only while the image device is exposed.

Preferably, the pre-image light comprises a light-pulses series which is generated during each exposure period when the imaging device is exposed. In this case, the light-pulse series during each exposure period has the same number of light pulses.

If the image device is repeatedly exposed when the operation device is operated for displaying the object image, the pre-image light can be radiated continuously while the image device is exposed and not exposed. In this case, the frequency of the pre-imaging light is not less than 300 Hz.

### BRIEF DESCRIPTION OF THE DRAWINGS

The objects and advantages of the present invention will be better understood from the following description, with reference to the accompanying drawings in which:

FIG. 1 is a front view, showing an digital camera having the lighting device;

FIG. 2 is a back view, showing the digital camera;

FIG. 3 is a block diagram of the digital camera;

FIG. 4 is a timing chart, showing the signal process at a CCD, and light radiation by the light device;

FIG. 5 is a view showing the light control of the pre-imaging light by adjusting the intensity;

FIG. 6 is a circuit diagram of a flash circuit in the first embodiment;

FIG. 7 is a flow chart, showing the lighting routine;

FIG. 8 is a timing chart showing radiation of the lighting device;

FIG. 9 is a view showing the light control of the pre-imaging light by adjusting the radiation period; and

FIG. 10 is a circuit diagram of a flash circuit in the second embodiment.

### DESCRIPTION OF THE PREFERRED EMBODIMENTS

The present invention will be described below with reference to the embodiments shown in the drawings.

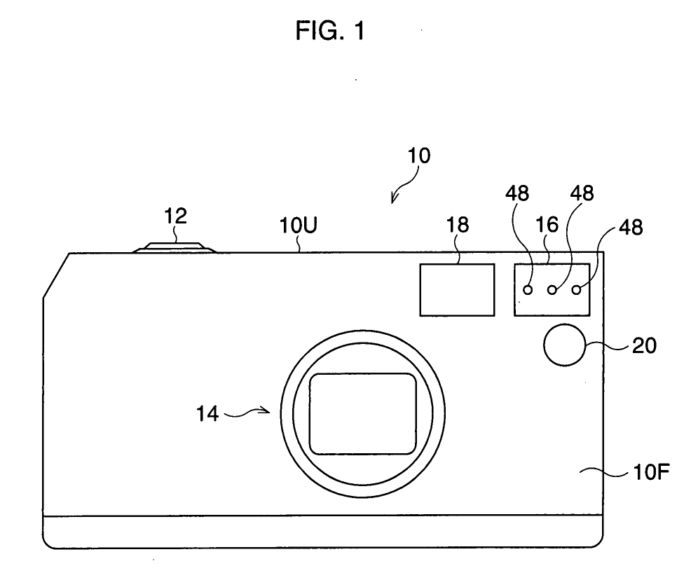

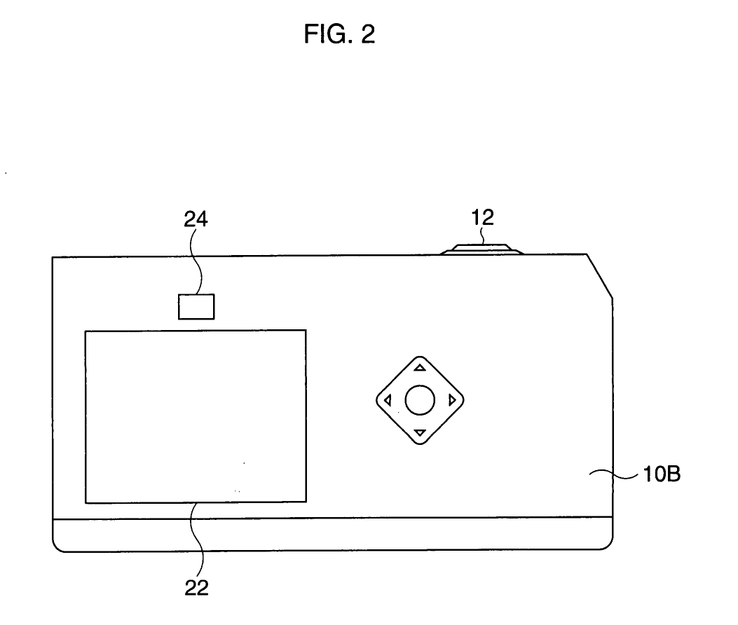

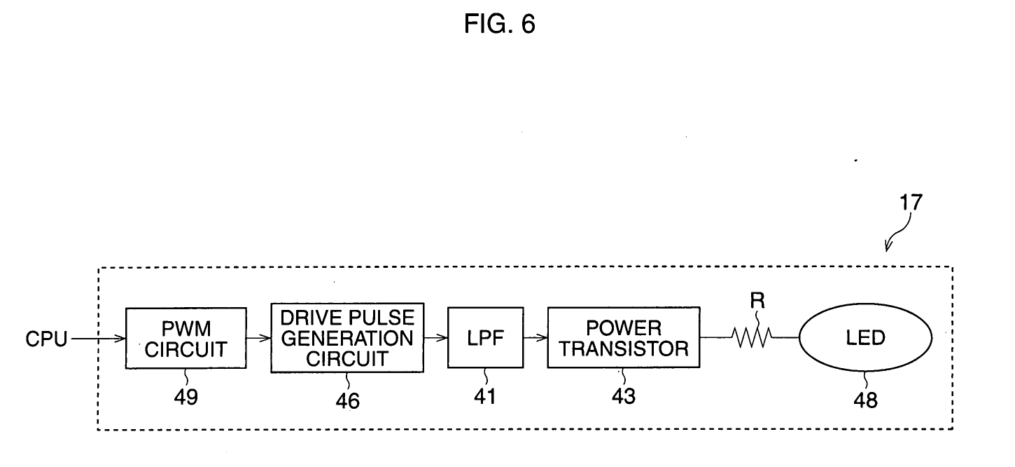

FIGS. 1 and 2 show the digital camera in the first embodiment. The digital camera 10 has an upper surface 10U, a front surface 10F, and a back surface 10B. The upper surface 10U is provided with a release button 12. The front surface 10F is provided with a photographing optical system 14, a lighting device 16, an optical finder 18, and a light control sensor (detection apparatus) 20. The lighting device 16 has a light source which consists of a white LED (a semiconductor lighting device) 48 (shown in FIG. 1 and FIG. 6). The light source (the LED 48) radiates luminance light including pre-imaging light for observing an object and an imaging light (flash light) for photographing the object as described below.

The back surface 10B is provided with a liquid crystal monitor (an indicating device) 22 where the object image is displayed, and a finder window 24 of an optical finder. The object image which is taken by the photographing optical system 14 is displayed on the monitor 22 while the release button is half-pushed in a photographing mode.

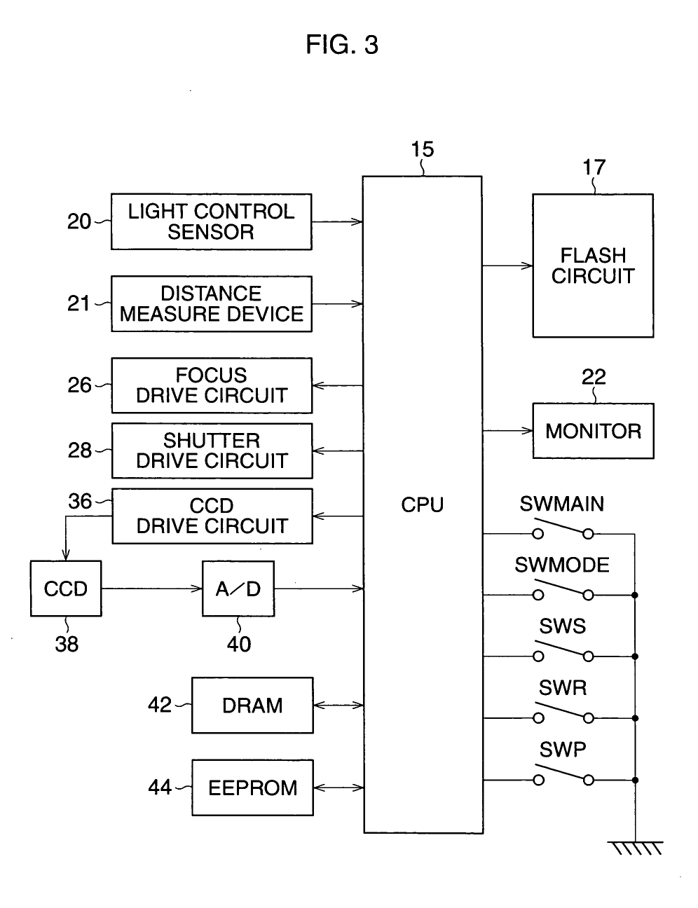

FIG. 3 shows a block diagram of the digital camera 10. CPU 15 is a control circuit which controls the digital camera 10. Several switches are connected to the CPU 15. The several switches include a main switch SWMAIN, a mode set switch SWMODE, a observing switch SWS, a release switch SWR, and a light mode switch SWP.

The main switch SWMAIN is a power switch (not shown in Figs.) of the digital camera 10, and is switched to the ON-state by an operation of the user, so that the CPU 15 begins working. The mode set switch SWMODE sends a signal which corresponds to a selected mode to the CPU 15. The selected mode is selected from one of a photographing mode (i.e. shooting mode), a play mode, an exposure mode, and so on. The selected mode is selected using a dial (not show in Figs.) which is provided on the surface of the digital camera 10. Namely, the dial is rotated and the selected mode is determined by a position where the dial is located. The case when the selected mode is the photographing mode will be described below.

The observing switch SWS is switched to the ON-state when the release button 12 is half-pushed. When the observing switch SWS is in the ON-state, the distance between the object and digital camera 10 (the object distance) is measured by a distance measuring device 21. The object distance data are sent to the CPU 15. At the CPU 15, a control signal is produced based on the object distance. The focusing of the optical system 14 is adjusted by a focus drive circuit 26 according to the control signal which is output from the CPU 15.

Further, when the observing switch SWS is switched to the ON-state, the monitor 22 starts displaying the object image taken by the photographing optical system 14 as a moving image. And the monitor 22 continues displaying the object image, while the observing switch SWS is in the ON-state. Namely, a user can observe the moving object image while the user half-pushes the release button. Therefore, on the monitor the user can confirm the composition of the object image which will be the photographing target. Further, the process, which is carried out when the observing switch SWS is switched to the ON-state, is called “the observation process” hereafter.

However, when the object is in the dark, the object image on the monitor 22 is also dark. In this case, the object image on the monitor 22 cannot be observed sufficiently. Therefore, in this embodiment pre-imaging light can be radiated during the observation process as the need arises in order to confirm the composition of the object.

Namely, while the light mode switch SWP is in the ON-state after being selected by a user, the light mode is set up. If the light mode is set up, a pre-imaging light is radiated by the light source while the observing switch SWS is in the ON-state.

Further, when the light mode switch SWP is in the OFF-state after being switched off by a user, a luminance depend mode is set up. In the luminance depend mode, whether the pre-imaging light is radiated is determined by the luminance of the object. Only when the luminance is less than a predetermined value, is the pre-imaging light radiated while the observing switch SWS is in the OFF-state. Furthermore, the greater the quantity of the radiated pre-imaging light, the lower the luminance of the object.

When the release button 12 is fully-pushed, the release switch SWR switches to the ON-state. If the release switch SWR is in the ON-state, a mechanical shutter (not shown in Figs.) is opened by a predetermined extent for a predetermined period by a shutter drive circuit 28 so that a CCD (imaging device) 38 is exposed. Further, the process, which is carried out when the release switch SWR is switched to the ON-state, is called “the photographing process” hereafter.

In this case, the lighting device 16 radiates imaging light (the flash light) to the object, if a strobe mode is set up. The quantity of the imaging light is calculated based on the object's luminance which is detected by the light control sensor 20, and the object distance which is measured by the distance measuring device 21. On the other hand, the lighting device 16 does not radiate the imaging light to the object unless the strobe mode is set up. Whether the strobe mode is set up is determined by the user before photographing.

When the user confirms the composition, the user does not look at the object in detail in the observation process. Therefore the pre-imaging light does not have to be so strong. On the other hand, the user usually looks at the photographed object image in detail. Therefore, the imaging light has to be a brighter light than the pre-imaging light in order to express the fine detail of the object.

The light source is provided on a flash circuit 17. The flash circuit 17 makes the light source radiate the pre-imaging light according to a control signal from the CPU 15 and controls the quantity of the pre-imaging light.

When the release switch SWR is switched to the ON-state and a mechanical shutter is opened, electric charge which corresponds to the object image is generated due to the photoelectric transfer effect of a light receiving portion of the CCD 38. The generated charge is stored in the photodiodes. The stored change is transferred to a vertical transfer portion of the CCD 38 so that the transferred charge is readout as a charge signal (image signal). The image signal is sent to an amplification circuit (not shown in Figs.). The image signal is amplified at the amplification circuit, and is changed to a digital signal from an analog signal at an analog-to-digital conversion circuit 40. The digitalized image signal is sent to the CPU 15 and undergoes many processes including a white balance adjustment, a gamma correction, and so on. Further, unnecessary charge which is stored in the photodiodes is drained out by a VOD (Vertical Overflow Drain) at the CCD 38. The CCD 38 is controlled by a CCD drive circuit 36.

The image signal is sent to a monitor drive circuit (not shown in the Figs.) from the CPU 15. The monitor drive circuit drives the monitor 22 according to the image signal so that the object image which corresponds to the image signal is displayed as a still image on the monitor 22. The image data of the object image is memorized in a DRAM 42 or a memory card (not shown in Figs) as the still image. On the other hand, while the release switch SWR is in the OFF-state and the observing switch SWS is in the ON-state, the object image, which corresponds to the image signal which is obtained by the CCD 38, is always displayed on the monitor 22 as a moving image. Further, the process for the CCD 38 to display the object image as the moving image is similar to the process to display a photograph of a still object image. Furthermore, an EEPROM 44 stores the necessary data to process the signal at the CPU 15.

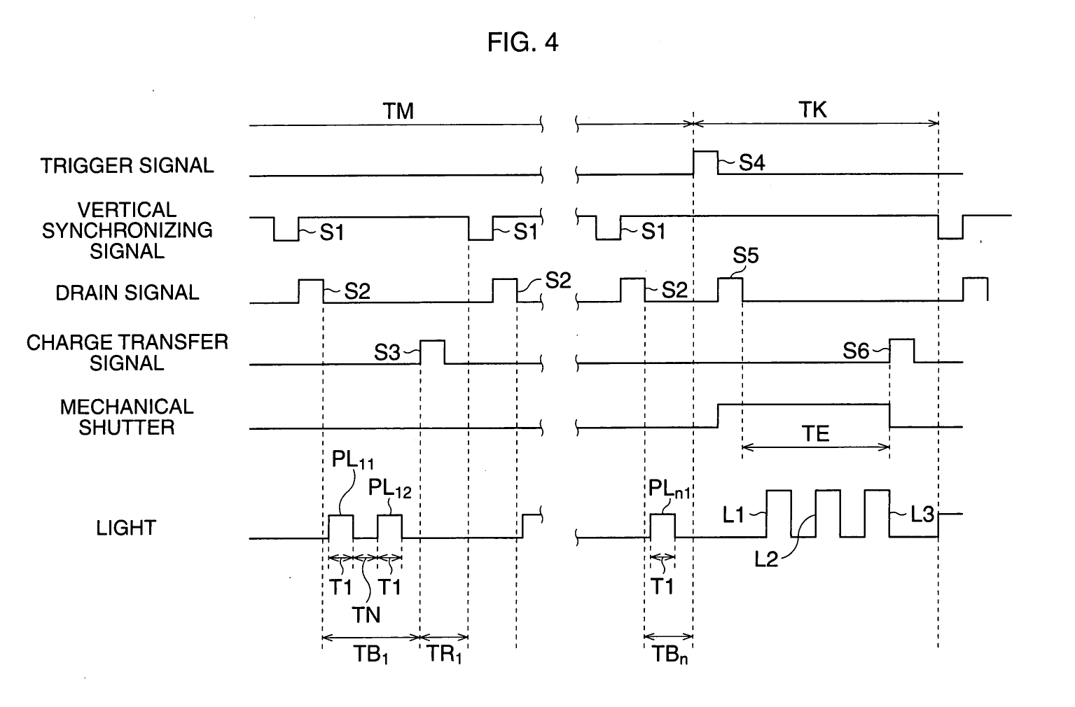

FIG. 4 is the timing chart showing the signal processes at the CCD 38 and the light radiated by the lighting device. The period of the observation process is the monitoring period TM. The period of the photographing process is a record period TK. Namely, while the release button 12 is being half-pushed the monitoring period TM continues, further when the release button 12 is fully-pushed the record period TK starts.

During the monitoring period TM, a vertical synchronizing signal S1 is input to the CCD drive circuit 36 from the CPU 15 at a predetermined interval. A drain signal S2 (pulse signal) to synchronize the vertical synchronizing signal S1 is generated at the CCD drive circuit 36.

Charge corresponding to the object image is generated in the photoelectric transfer device of the CCD 38. The generated charge is stored in the photodiode. When the drain signal S2 is generated, the photodiode drains the stored charge and starts storing the generated charge again. From the end of the input of the drain signal S2 to the start of the input of the charge transfer signal S3 is an exposure period TB₁. The CCD 38 is exposed during the exposure period TB₁. Therefore, the charge stored during the exposure period TB₁, is transferred to the vertical transfer portion during a charge transfer period TR₁. The charge continues to be stored in the photodiodes after the input of the charge transfer signal S3. However the charge which is stored until the inputting of the next drain signal S2 is not used. Thereafter it is drained out.

The object image corresponding to the transferred charge which is stored during the first exposure period TB₁, is displayed on the monitor 22. The pre-imaging light is radiated to the object during the first exposure period TB₁. Therefore, the object image, to which the pre-imaging light is radiated, is displayed on the monitor 22.

The exposure periods (TB₁, TB₂, . . . , TBₙ) are generated cyclically, and the CCD 38 is repeatedly exposed, namely the CCD 38 repeats forming the object images and then the object images are displayed on the monitor 22 continuously as a moving image.

The charge stored except for during the exposure periods (for example during the charge transfer period) is drained. Namely, the object image which is formed on the CCD 38 except for that during the exposure periods is not displayed on the monitor 22, therefore the pre-imaging light does not have to be radiated except for during the exposure periods. Accordingly, in this embodiment the pre-imaging light is not radiated except for during the exposure periods. Due to this, the light source does not use the excess electricity and can radiate pre-imaging light efficiently.

In this case, the pre-imaging light radiated during each exposure period (for example TB₁) consists of a light-pulse series (PL₁₁, PL₁₂) which is radiated cyclically. And the light-pulse series repeats a radiation period T1 and stop radiation periods TN cyclically. The radiation cycle of the light-pulse series is shorter than the exposure period cycle, namely the radiation period T1 of the light pulse is shorter than the exposure period TB₁. Further, each light-pulse series (for example PL₁₁, PL₁₂) is radiated perfectly within the exposure period TB₁. Namely each light-pulse series is synchronized with the exposure period TB₁.

During each of the exposure periods (TB₁, TB₂, . . . , TBₙ) each light-pulse series has same predetermined radiation cycle. Therefore, pre-imaging light radiated during each exposure period (for example TB₁) consists of a light-pulse series which has exactly the same number of light pulses. Furthermore, each light pulse has the same pulse height and the same pulse width and the quantity of pluses in each light-pulse series is the same unless the quantity of light is adjusted. Due to this, the image object on the monitor 22 does not flicker.

While displaying a moving image on the monitor 22, if the release button 12 changes to the ON-state, namely the release switch SWR is fully-pushed, the trigger signal is input to the shutter drive circuit 28 and the CCD drive circuit 36. If the trigger signal is input, the period TM finishes and the record period TK starts.

Further, in FIG. 4, the release switch SWR is fully-pushed during the nth exposure period TBₙ, therefore the nth exposure period TBₙ finishes halfway. Of course, the period TK can start any time in the period TM.

When starting the record period TK, the drain signal S5, which is synchronized with the trigger signal S4, is generated at the CCD drive circuit 36. At the same time of generating the drain signal S5, the shutter drive circuit 28 opens the mechanical shutter hence the object is photographed during the photographing exposure period TE. Namely, when the inputting of the drain signal S5 finishes, the CCD 38 starts to be exposed. And the CCD 38 continues being exposed until the charge transfer signal S6 is generated, namely during the photographing exposure period TE. Charges stored during the exposure period TE are transferred after the period TE, similar to the monitoring period TM. The object image is produced based on the transferred charges. And then, the object image is displayed on the monitor 22 and is memorized in the memory card.

In this case, the imaging light (flash light) which consists of a light-pulse series is radiated during the period TE. Therefore, the memorized object image corresponds to the object to which the image light is radiated.

Furthermore, each light pulse of the pre-imaging light (PL₁₁, PL₁₂, . . . , PLₙ₁) and each light pulse (L₁, L₂, and L₃) of the imaging light has the same pulse width. Therefore, the radiation period per unit time (for example 1 sec.) of the pre-imaging light is as long as that of the imaging light.

On the other hand, the pulse height of the pre-imaging light (PL₁₁, PL₁₂, . . . , PLₙ₁) is smaller than that of the imaging light (L₁, L₂, and L₃) as shown in FIG. 4. Therefore, the intensity of each light pulse (PL₁₁, PL₁₂, . . . , PLₙ₁) of the pre-imaging light is smaller than that of the imaging light (L₁, L₂, and L₃). Accordingly, the quantity of the pre-imaging light is smaller than that of the imaging light. In this case, “the quantity of the light” means the quantity of the light per unit time (for example 1 sec.).

As describe above, in this embodiment, the CPU 15 controls the timing when the illumination light is radiated, and the quantity of the illumination light, so that the pre-imaging light and the imaging light are radiated appropriately.

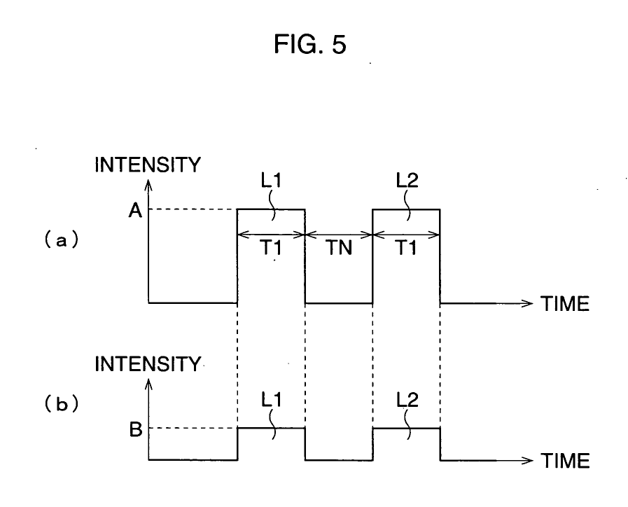

In this embodiment, the quantity of the illumination light (the pre-imaging light and the imaging light) is changeable. How to change the quantity of the illumination light will be explained using FIG. 5. FIG. 5 shows the light pulse when the quantity of the pre-imaging light is changed. In this embodiment, the intensity of each pulse (for example L1) which is composed of the light-pulse series, is changed in order to change the quantity of the pre-imaging light.

For example, when the basic pre-imaging light (a) changes to the changed pre-imaging light (b), namely the quantity of the pre-imaging light changes to the quantity B/A with respect to that of the basic pre-imaging light (a), the intensity of each pulse (for example L1) changes by the intensity B/A. In this case, the pulse width (radiation period) and pulse frequency are not changed.

When the intensity of the pre-imaging light is changed, the function of the flash circuit 17 will be explained below.

FIG. 6 shows the flash circuit 17. The flash circuit 17 includes a PWM (Pulse Width Modulation) circuit 49, a drive pulse generation circuit 46, a LPF (low-pass filter) 41, a power transistor 43, a resistor R, and the LED 48. The flash circuit 17 adjusts an electric current which flows in the LED 48 so as to control the intensity of the illumination light of the LED 48.

A radiation control signal to control the radiation of the LED 48 is input to the PWM circuit 49 from the CPU 15. At the PWM circuit 49, a pulse signal having a predetermined pulse width and a predetermined frequency is generated based on the radiation control signal. The pulse width is determined based on the duty ratio. In this embodiment, the pulse signal is a repetition of 0 (OFF-period) and 1 (ON-period) during the period T1, and is 0 during the period TN. In this case, the pulse width of 1 (ON-period time) with respect to the pulse width of 0 (OFF-period time) is determined by the duty ratio during the period T1. The pulse signal is input to the drive pulse generation circuit 46. At the pulse generation circuit the electronic voltage and the current of the pulse signal are changed to match the driving of the LED 48 so that the pulse signal is converted to a drive signal (drive pulse signal) The drive signal is smoothed at the LPF 41 during each period T1, and the smoothed drive signal is inputted to the LED 48 through the power transistor 43 and resistor R. The LED 48 radiates the pre-imaging light based on the smoothed drive signal. Therefore, the pre-imaging light consists of the light pulse having the same pulse width and same frequency.

The electric current which flows in the LED 48 is determined based on each pulse width of 1 (the duty ratio) of the pulse signal, which is adjusted at the PMW circuit 49. In other words, the pulse height, namely the pulse intensity of the light pulse is controlled according to the duty ratio and it is adjusted at the PMW circuit 49.

Further, the quantity of the imaging light is different from the quantity of the pre-imaging light in this embodiment, therefore the quantity of the imaging light is changed by the above described method.

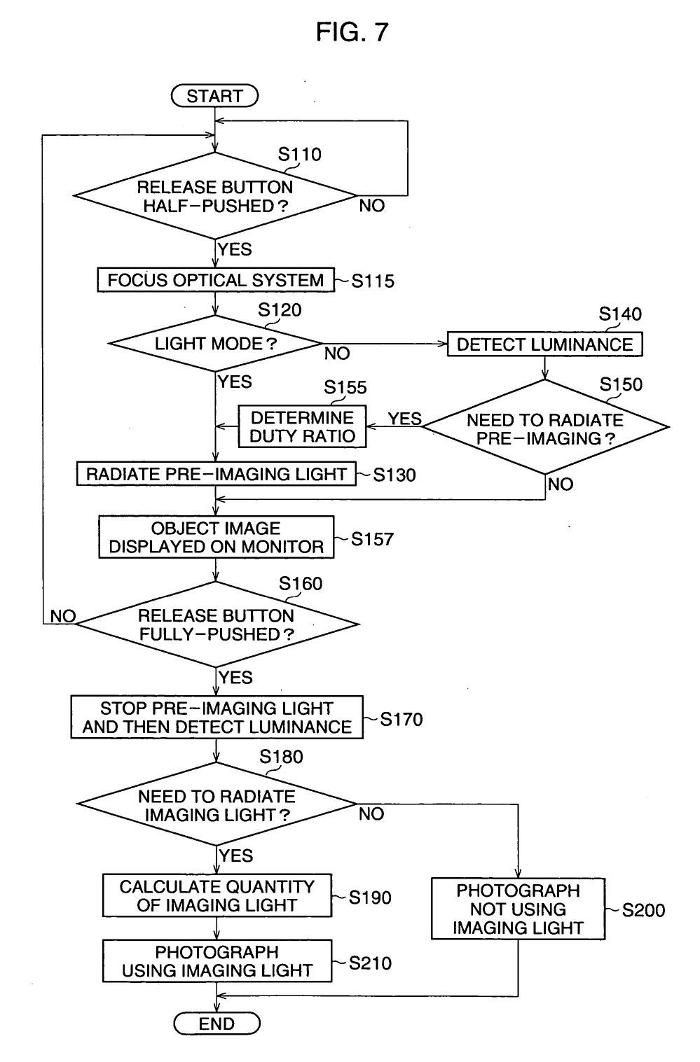

FIG. 7 shows a flowchart of the lighting process routine for the lighting device 16. This routine starts when the photographing mode is selected for the digital camera 10.

At step 110, whether the release button is half-pushed, namely whether the observing switch SWS is in the ON-state is determined. If the observing switch SWS is in the ON-state, the object distance between the object and digital camera 10 is measured by a distance measuring device 21 and then the optical system 14 is focused automatically at step 115. On the other hand, unless the release button is half-pushed, step 110 is repeated.

At step 120, whether the light mode is set up, namely whether the lighting mode switch SWP is in the ON-state is determined. If the light mode is set up, the lighting device 16 is controlled by the flash circuit 17, and radiates the pre-imaging light at a predetermined light quantity. On the other hand, if the luminance depend mode is set up, namely unless the light mode is set up, whether the pre-imaging light is radiated is determined in the below step S140.

At step S140, the luminance of the object is detected by the light control sensor 20. At step S150, whether the pre-imaging light has to be radiated is determined based on the luminance detected by the sensor 20. Namely, weather the luminance of the object is lower than a predetermined value is determined.

If the luminance is lower than a predetermined value, the duty ratio is determined based on the luminance at step S155. After the duty ratio is determined, the pre-imaging light of which the quantity is determined based on the duty ratio, is radiated at step 130. In this case, the larger the quantity of the pre-imaging light, the smaller the luminance (the smaller duty ratio). On the other hand, unless the luminance is lower than a predetermined value, the pre-imaging light is not radiated and the routine goes to step S157.

And then the object image which is taken by the photographing optical system 14 is displayed as a moving image on the monitor 22 at step S157. If the pre-imaging light is radiated at step 130, the object image corresponds to the object to which the pre-imaging light is radiated.

At step S160, whether the release button is fully-pushed is determined. If the release button is fully-pushed, the object is photographed in the below step S170. Unless the release button is fully-pushed, the routine goes back to step S110, and then, whether the release button is half-pushed is determined at step S110. If the release continues to be half-pushed, the routine goes to step S115 below and then the pre-imaging light continues to radiate at step S130 for example in case of the light mode. On the other hand, unless the release is half-pushed, the routine waits at step S110, therefore the pre-imaging light stops being radiated and the object image stops being displayed on the monitor 22.

At step 170, the luminance of the object is detected by the light control sensor 20 in order to photograph the object. In this case, if the pre-imaging light was radiated, the luminance of the object could not be measured correctly, therefore the pre-imaging light stops lighting before the luminance is detected.

At step 180, whether the-imaging light (the flash light) has to be radiated when the object is photographed, namely whether a strobe mode is set up, is determined. Further, the strobe mode is set up beforehand by pushing a strobe button (not shown in Fig.) for example.

If the strobe mode is set up, the quantity of imaging light is calculated based on the object distance measured at step 115 and the luminance detected at step S170, and then the object is photographed at step S210 using the flash light of which the quantity is determined at step S190. Unless the strobe mode is setup, the object is photographed without using the flash light at step S200.

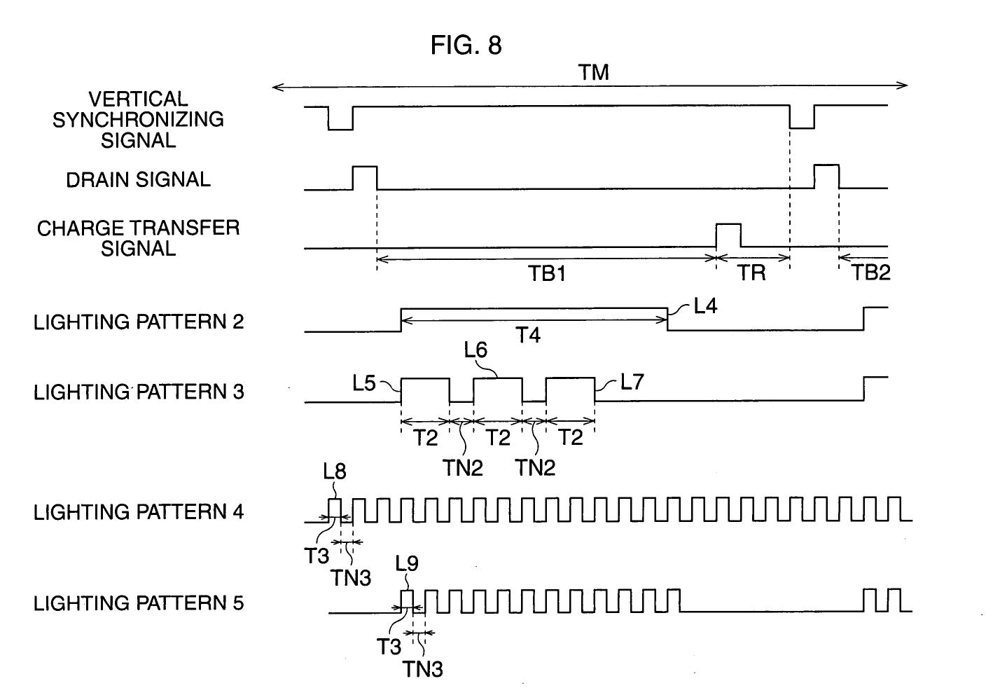

FIG. 8 shows the second to fifth embodiments. The light patterns of the pre-imaging light in the 2nd to 5th embodiments are the lighting patterns 2 to 5, respectively. The second to fifth embodiments are the same except for the lighting patterns.

As shown in the lighting patterns 2 and 3, of the second and third embodiment, the number of light pulses in each light-pulse series for each exposure period is changed from that in the first embodiment. The number of light pulses in each light-pulse series is only one in the second embodiment, and is three in the third embodiment.

Of course, each light-pulse series is synchronized with each exposure period in a similar way to that in the first embodiment. Furthermore, the light pulse is cyclically radiated, and each radiation period T2 has the same length and each stop radiation period TN2 has the same length.

In the forth embodiment, the pre-imaging light is radiated continuously during the monitoring period TM, whether it is the exposure period TB or not. The light pulse in the forth embodiment is radiated cyclically and then has a predetermined radiation cycle to repeat the radiation period T3 and the stop radiation period TN3 continuously. Therefore, the light-pulse series during each of the exposure period does not have exactly the same number of the light pulses. Each quantity of the light pulses during each of the exposure periods is not same even if each light pulse has the same pulse height and the same pulse width.

However, in the fourth embodiment, the predetermined radiation cycle is much shorter than the exposure cycle and the quantity of pre-imaging light during each of the exposure periods is almost the same. Therefore, the user does not notice the quantity difference between each exposure cycle and the pre-imaging light does not flicker either.

In the fourth embodiment, the pre-imaging light is radiated except for during the exposure period TB1 and is not used for lighting the object displayed on the monitor 22. However, the CPU 15 does not have to control the LCD 48 in order to synchronize the light-pulse series with exposure cycle as in the first embodiment.

Further, the user does not feel that the pre-imaging light is flickering, if the frequency of the light pulse is not less than 300 Hz.

In the fifth embodiment, the light pulse of the pre-imaging light is the same as that in the fourth embodiment. However, the light-pulse series during each of the exposure periods is synchronized with each exposure period in the fifth embodiment. Namely, the pre-imaging light is radiated only during each exposure period. In this pattern, the pre-imaging light is not radiated except for during the exposure period TB. Therefore, the use of electricity is lower than that in the fourth embodiment.

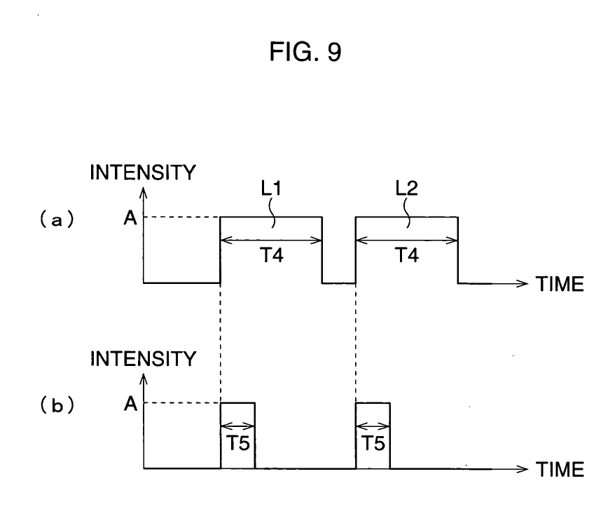

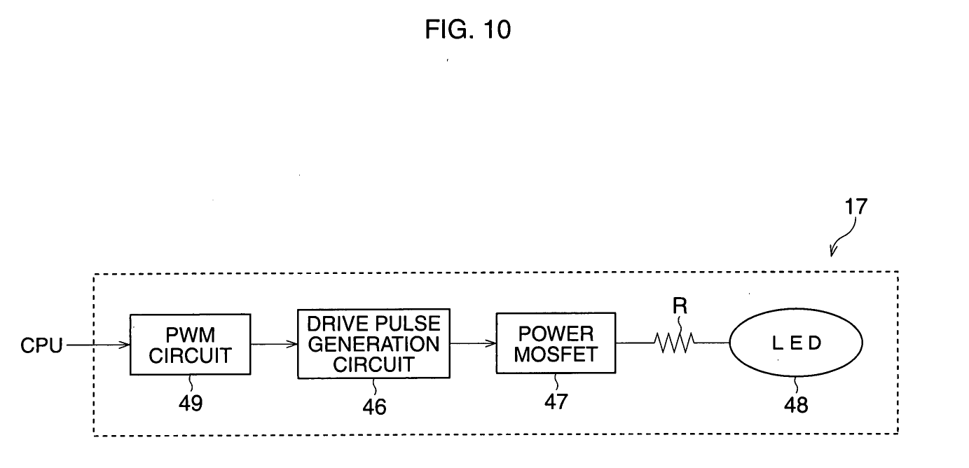

A sixth embodiment will be explained using FIGS. 9 and 10. The sixth embodiment has the same structure as that of the first embodiment except for the flash circuit 17 and the method of controlling the quantity of illumination light. Namely, in the first embodiment, the intensity of each the light pulses is changed in order to adjust the quantity of the illumination light, however in the second embodiment the width (the radiation period) of each light pulse is changed in order to adjust the quantity of the illumination light.

For example, if the basic pre-imaging light (a) changes to the changed pre-imaging light (b), namely if the light quantity changes to the quantity of T5/T4 with respect to that of the basic pre-imaging light (a), the radiation period (pulse width) of each pulse (for example L1) changes to the radiation period of T5/T4 with respect to that of each pulse (for example L1). In this case, the pulse intensity and pulse frequency are not changed.

When the radiation period of the pre-imaging light is changed, the function of the flash circuit 17 will be explained below. Further, the same portions as in the first embodiment are referred to using the same symbol in FIG. 10.

FIG. 10 shows the flash circuit 17. The flash circuit 17 includes a PWM circuit 49, a drive pulse generation circuit 46, a power MOSFET 47, a resistor R, and the LED 48. The flash circuit 17 adjusts a duty ratio of each light pulse so as to control the intensity of the illumination light of the LED 48.

A radiation control signal to control the radiation of the LED 48 is input to the PWM circuit 49 from the CPU 15. The radiation control signal has information about a duty ratio, frequency, and so on. At the PWM circuit 49, a pulse signal is generated, and at the drive pulse generation circuit 46 the electronic voltage and current of the pulse signal are changed to match the driving of the LED 48 so that the pulse signal is converted to the drive signal. The drive signal is input to the LED 48 through the power MOSFET 47 and resistor R. The LED 48 radiates the pre-imaging light which consists of the light pulse having the predetermined duty ratio and the predetermined frequency based on the radiation control signal.

In this case, the duty ratio (for example T4/(T4+TN4) in FIG. 9) of the light-pulse series is the same as the duty ratio contained in the radiation signal's information. Namely, the radiation period and the stop radiation period of each light-pulse series is determined based on the duty ratio information of the radiation signal. Therefore, the duty ratio contained in the radiation signal's information, is controlled so that the radiation period and the stop radiation period can be adjusted in this embodiment.

In the first and sixth embodiments, one of the intensity of the light pulse or the radiation period of the light pulse is changed. However, both the intensity of the light pulse and the radiation period can be changed in order to control the quantity of pre-imaging light.

Further, in the first to sixth embodiments, the pre-imaging light and the imaging light consist of the light pulses. However, the pre-imaging light and the imaging light can consist of other light.

Furthermore, in the first to sixth embodiments, the observation process occurs when the release button is half-pushed, however the observation process can start when the user's eye approaches to the finder window 24. Further, when the observation process starts, the pre-imaging light is radiated or the luminance of the object is detected in order to determine whether the pre-imaging light is radiated and the object image is displayed on the monitor 22.

In this case, the digital camera 10 is provided with a radiation device and an iris detection CCD inside the optical finder 18. The radiation device radiates light. The iris detection CCD detects the light which is radiated by the radiation device and which is reflected by the human iris. When the iris CCD detects the reflected light, it outputs a signal and the observing switch SWS switches to the ON-state. Due to this, the observation process starts.

In this case, if the frequency of the light pulse of the pre-imaging light is not less than 30 Hz, the user does not feel pre-imaging light flickers.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2003-361848 (filed on Oct. 22, 2003) which is expressly incorporated herein, by reference, in its entirety.

1. A lighting device for a photographing apparatus, said lighting device comprising:
a light source that radiates illumination light to an object, said illumination light comprising pre-imaging light and imaging light and, a light-control apparatus that controls said light source in such a manner that said pre-imaging light is radiated before said object is photographed, and said imaging light is radiated when said object is photographed, the quantity of said pre-imaging light being smaller than the quantity of said imaging light.

2. A lighting device according to claim 1, wherein said light-control apparatus controls the timing when said illumination light is radiated and the quantity of said illumination light.

3. A lighting device according to claim 1, wherein said light-control apparatus changes at least one of the radiation period and the intensity of said illumination light in order to control the quantity of said pre-imaging light and said imaging light.

4. A lighting device according to claim 1, wherein said pre-imaging light comprises a light-pulse series which has a predetermined radiation cycle and which repeats a radiation period and a stop radiation period.

5. A lighting device according to claim 4, wherein said light-control apparatus changes at least one of the intensity of said light pulse and said radiation period.

6. A lighting device according to claim 1, said lighting device further comprising a detection apparatus that detects the luminance of said object,
wherein said light-control apparatus controls said light source in such a manner that said pre-imaging light is radiated when said luminance is less than a predetermined luminance.

7. A lighting device according to claim 6, wherein said quantity of said pre-imaging light is determined based on said luminance.

8. A lighting device according to claim 7, said lighting device further comprising a switching apparatus for switching between a light mode and a luminance depend mode,
wherein said light-control apparatus controls said light source in such a manner that said pre-imaging light is radiated regardless of said luminance when said light mode is selected, and that said pre-imaging light is radiated based on said luminance when said luminance depend mode is selected.

9. A lighting device according to claim 1, wherein said light source includes a semiconductor lighting device radiating white light.

10. A lighting device according to claim 1, wherein said light-control apparatus comprises:
a detection apparatus that detects a luminance of said object,
a pulse generation circuit that generates a drive pulse signal, said drive pulse signal having ON-period time and OFF-period time per unit time, controlled based on said luminance, and
a smoothing circuit that smoothes said drive pulse signal so as to generate a smoothed drive signal;
wherein said smoothed drive signal is input to said light source so that said light source radiates said illumination light based on said luminance.

11. A photographing apparatus comprising:
a light source that radiates illumination light to an object, said illumination light comprising pre-imaging light and imaging light,
a light-control apparatus that controls said light source in such a manner that said pre-imaging light radiates before said object is photographed, and said imaging light radiates when said object is photographed, the quantity of said pre-imaging light being smaller than the quantity of said imaging light,
an imaging device that forms an object image of said object, and
an indicating device that displays said object image.

12. A photographing apparatus according to claim 11, wherein said pre-imaging light is radiated to said object in order to observe said object image on said indicating device.

13. A photographing apparatus according to claim 11, said photographing apparatus further comprising an operation device,
wherein said pre-imaging light is radiated when said operation device is operated for displaying said object image, and said imaging light is radiated when said operation device is operated for photographing said object.

14. A photographing apparatus according to claim 13, wherein said image device is repeatedly exposed when said operation device is operated for displaying said object image, and said pre-image light is radiated only while said image device is exposed.

15. A photographing apparatus according to claim 14, wherein said pre-image light comprises a light-pulse series which is generated during each exposure period when said imaging device is exposed.

16. A photographing apparatus according to claim 15, wherein said light-pulse series during each said exposure period has the same number of light pulses.

17. A photographing apparatus according to claim 13, wherein said image device is repeatedly exposed when said operation device is operated for displaying said object image, and said pre-image light is radiated continuously while said image device is exposed and not exposed.

18. A photographing apparatus according to claim 17, wherein the frequency of said pre-imaging light is not less than 300 Hz.

19. A lighting device according to claim 11, wherein said light-control apparatus comprises:
a detection apparatus that detects a luminance of said object,
a pulse generation circuit that generates a drive pulse signal, said drive pulse signal having ON-period time and OFF-period time per unit time, controlled based on said luminance, and
a smoothing circuit that smoothes said drive pulse signal so as to generate a smoothed drive signal;
wherein said smoothed drive signal is input to said light source so that said light source radiates said illumination light based on said luminance.
